(19) United States
(12) Patent Application Publication
(10) Pub. No.: US 2025/0049077 A1
(43) Pub. Date: Feb. 13, 2025

(54) INSECT-BASED FEED USING FREEZE-DRYING TECHNIQUE AND METHOD FOR PRODUCING THE SAME

(71) Applicant: Dong Eun Kim, Seoul (KR)

(72) Inventors: Dong Eun Kim, Seoul (KR); Min Gyu Seo, Seoul (KR)

(21) Appl. No.: 18/721,856

(22) PCT Filed: Jul. 26, 2022
(86) PCT No.: PCT/KR2022/010949

§ 371 Date: Jun. 19, 2024

(30) Foreign Application Priority Data
Dec. 20, 2021 (KR) 10-2021-0182533

(51) Int. Cl. A23K 10/20; A23K 20/163; A23K 30/20; A23K 40/20

(52) U.S. Cl. CPC A23K 10/20; A23K 20/163; A23K 30/20; A23K 40/20

(57) ABSTRACT

The present disclosure proposes that insects be used instead of meat or fish, which have been conventionally used as a raw material for feed produced using a freeze-drying technique. In at least one embodiment of the present disclosure, disclosed is a feed production method including a step of preparing a dough by combining insect powder and starch, preparing a mixture using the dough, molding the mixture, and freeze-drying the mixture. In at least another embodiment of the present disclosure, disclosed is a feed produced using a freeze-drying technique, including insect powder and starch.

### BACKGROUND OF THE INVENTION

The present disclosure relates to the production of feed using a freeze-drying technique, and more particularly, to production of a feed by applying the freeze-drying technique to insects or insect powder.

Freeze-drying (or Lyophilization) is a type of drying technique. After freezing an object, the atmospheric pressure around the object is lowered to sublimate the solid-phase water contained in the object to a gaseous phase to dry the object. The freeze-drying technique dries the object by sublimating the ice by supplying thermal energy to the frozen object, and thus there is little physical and chemical change of the object. Since the freeze-drying technique can remove only moisture while preserving the original shape of the object as much as possible, nutrients such as vitamins contained in the object can be maintained.

The freeze-dried object has a porous structure (empty space created by sublimation of ice). The freeze-dried object also has an advantage of excellent reconstitution. That is, the object restores the tissue before drying when it undergoes a rehydration process of adding moisture again. Freeze-dried foods are generally light in weight, can be distributed at room temperature, and are suitable for making foods that have a long shelf life. Without contact with moisture, freeze-dried food can be stored at room temperature for several years.

The freeze-drying technique having such advantages is used for drying various raw materials of food or food itself, and is also used to manufacture feed, including pet food. Food such as pet food produced using the freeze-drying technique can be found even at general pet shops.

Raw materials for conventional feed formed using the freeze-drying technique include meat (cow, pig, chicken, etc.) or fish. Meat or fish is included in the feed as a source of protein. However, meat or fish contains a large amount of water, and thus the mass thereof is reduced to ⅕ in the freeze-drying process. Therefore, the amount of feed that can be produced is very small compared to the raw materials when the feed is produced by freeze-drying meat or fish.

Therefore, the present disclosure has been made in view of the above problems, and it is one object of the present disclosure to provide a feed with very little mass loss even after drying using an insect protein source as a raw material for freeze-dried feed.

### SUMMARY OF THE INVENTION

The present disclosure proposes that insects be used instead of meat or fish, which have been conventionally used as a raw material for feed produced using a freeze-drying technique.

In at least one embodiment of the present disclosure, the method may include preparing a dough by combining insect powder and starch, preparing a mixture using the dough, molding the mixture, and freeze-drying the mixture. The feed producing method may further include quickly freezing the mixture. The preparing of the mixture may include mixing the dough with at least one of eggs, milk, water, or oil. A raw material of the starch is at least one of wheat, potato, flaxseed, barley, peas, lentils, chickpeas, brown rice, corn, sweet potato, tapioca, pumpkin, glutinous rice, or rice. The combining of the insect powder and the starch may include at least one of combining the raw material of the starch with the insect powder, boiling the raw material and combining the same with the insect powder, combining a powdered formulation of the raw material with the insect powder, or extracting the starch from the raw material and combining the extracted starch with the insect powder. The preparing of the mixture may include mixing the dough and an additional additive, wherein the additional additive is all or part of at least one of pumpkin, carrot, sweet potato, anchovy, dried pollack, zucchini, sweet pumpkin, tomato, dried kelp, blueberry, bok choy, or rosemary extract. A raw material of the insect powder is at least one of feed insects including a brown mealworm, a Zophobas atratus, a Hermetia illucens, a housefly, a two-spotted cricket, an Oriental garden cricket, a silkworm moth, a Chironomidae larva, or other insects determined and publicly notified by government departments or institutions.

In at least one other embodiment of the present disclosure, a feed produced using a freeze-drying technique is disclosed. The feed may include insect powder and starch. The feed may further include at least one of eggs, milk, water, or oil. A raw material of the starch may be at least one of wheat, potato, flaxseed, barley, peas, lentils, chickpeas, brown rice, corn, sweet potato, tapioca, pumpkin, glutinous rice, or rice. The feed may further include all or part of at least one of pumpkin, carrot, sweet potato, anchovy, dried pollack, zucchini, sweet pumpkin, tomato, dried kelp, blueberry, bok choy, or rosemary extract. A raw material of the insect powder may be at least one of feed insects including a brown mealworm, a Zophobas atratus mealworm, a Hermetia illucens, a housefly, a two-spotted cricket, a Teleogryllus cricket, a silkworm moth, a Chironomidae larva, and other insects determined and publicly notified by the Minister of Agriculture, Food and Rural Affairs. A weight ratio of the raw material constituting the feed may be selected according to at least one of a nutritional standard of AAFCO (Association of American Feed Control Officials), a standard of “Nutrient Requirements of Dogs and Cats” published by NRC (National Research Council), or the European Pet Food Industry Federation (FEDIAF/European standards, non-profit organization).

According to an embodiment of the present disclosure, a feed producing method may maximize the amount of produced feed compared to the raw material by using insects as a raw material for the feed produced using the freeze-drying technique, and may produce various types of feed that were not previously available.

### BRIEF DESCRIPTION OF THE DRAWINGS

FIG. 1 is an exemplary flowchart illustrating food or feed production using a freeze-drying technique.

FIG. 2 is an exemplary flowchart illustrating a process method for freeze-drying.

FIG. 3 illustrates an exemplary method of producing feed with insects as a raw material using a freeze-drying technique according to the present disclosure.

FIG. 4 is a photograph of an embodiment of feed with insects as a raw material using a freeze-drying technique according to the present disclosure.

### DETAILED DESCRIPTION OF THE PREFERRED EMBODIMENTS

Hereinafter, a feed with an insect as a raw material using a freeze-drying technique and a method of producing the same, which have not been employed conventionally, will be described. As used herein, the term “feed” follows the definition of feed under the Control Of Livestock And Fish Feed Act. It should be understood that addition, modification, or deletion of the embodiments presented herein as well as components applicable to the embodiments of the present disclosure by those skilled in the art are within the scope of the disclosure. The sequential order of steps presented in the present disclosure is merely exemplary. In some cases, two or more steps may be performed in parallel, the order of the two or more steps may be changed. Alternatively, one or more steps may be omitted. The terms used herein are intended to describe embodiments and do not limit the scope of the present disclosure. A singular expression includes a plural expression unless the context clearly indicates otherwise. It should be understood that the terms “include” and/or “including” used in the present disclosure indicate the presence of the corresponding component and/or characteristics, but does not preclude the presence or addition of one or more other components and/or characteristics. Also, as used herein, the expression “A or B” may be used to mean any of “A,” “B,” or “A and B.” It should be understood that the expression “and/or” means all possible combinations of one or more of the listed items.

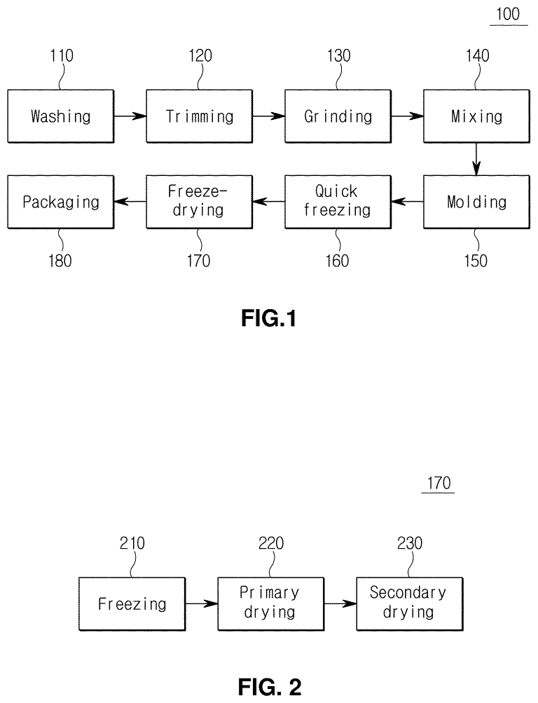

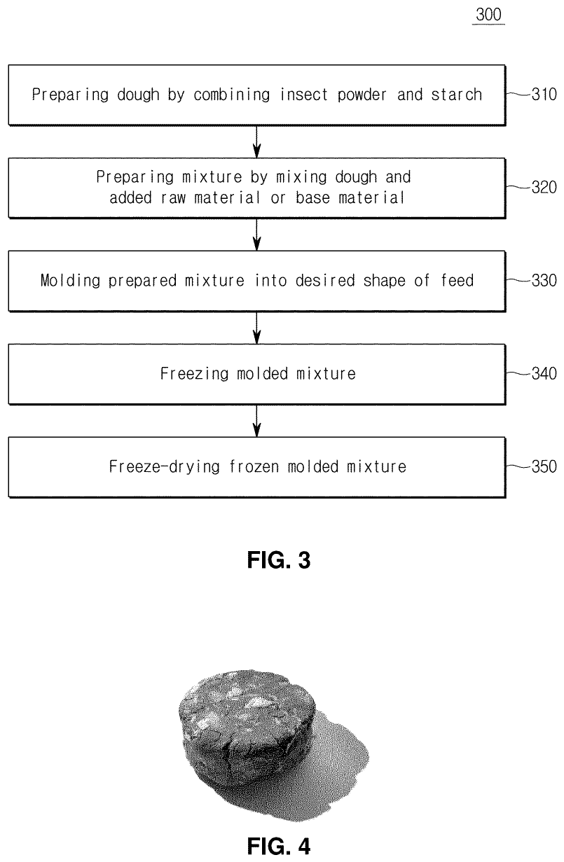

Foods and feeds produced using a freeze-drying technique are distributed. FIG. 1 is an exemplary flowchart 100 of food or feed production using the freeze-drying technique.

In the washing step 110, raw materials (or materials) used in the production of food or feed are washed. This is a process of removing foreign substances (e.g., soil) that may remain in the raw materials.

The grooming step 120 is a process of removing parts inappropriate to be included in food or feed from the raw materials. For example, in producing feed for a companion animal, parts that the companion animal cannot eat are removed in the trimming step 120. When necessary, a process of deforming the raw material by, for example, boiling or steaming the raw material may be added to the trimming step 120.

The grinding step 130 is a process of processing trimmed raw materials to facilitate mixing of the materials. For example, this step corresponds to a process of grinding the trimmed raw materials in a grinder or kneading them in a kneader.

The mixing step 140 is a process of mixing the raw materials processed in the grinding step 130. It is a process of mixing the raw materials, and as a mixing method. An appropriate method may be selected to mix the raw materials well.

The molding step 150 is a process of molding the mixed raw materials (mixture) into a predetermined shape. In this process, the mixture is turned into a standardized form using a predetermined mold. The predetermined shape may vary depending on the food or feed produced. Even when the same raw material is used, it may be molded into various shapes.

The quick freezing step 160 is a process of quickly freezing the molded mixture at a low temperature below zero. In the quick freezing step 160, the room temperature is decreased to a low temperature of −20 to −50° C. or a low temperature of −40° C. to freeze an object such as a molded mixture. However, embodiments are not limited thereto and the process may be performed at various temperatures according to situations. In the quick freezing step 160, after the temperature is decreased to a predetermined low temperature, the object such as the molded mixture may be further frozen at the low temperature. In at least one embodiment, quick freezing may be performed for a duration within 1 hour by decreasing the temperature of the object to a temperature lower than or equal to −40° C. for freezing. In another embodiment, quick freezing may be performed for a duration within 30 minutes by decreasing the temperature of the object to a temperature lower than or equal to −40° C. for freezing. The quick freezing step 160 may be performed by lowering not only the temperature but also the ambient air pressure.

The freeze-drying step 170 is a process of lowering the ambient air pressure of the frozen mixture and then sublimating frozen moisture at a low temperature to dry the frozen mixture. A machine capable of performing both the quick freezing step 160 and the freeze-drying step 170 may be used. Alternatively, the quick freezing step 160 and the freeze-drying step 170 may be performed using different apparatuses. For example, the quick freezing step 160 may be performed using a freezer, and the freeze-drying step 170 may be performed using a freeze dryer. As the freezer, the freeze dryer, and/or the machine capable of performing both the quick freezing step 160 and the freeze-drying step 170, a commercial product may be used, or an apparatus with a specification desired by a person skilled in the art may be devised.

The packaging step 180 is a process of packaging the completed mixture (frozen dried product) for an operation such as distribution. In this process, foreign matter inspection or weight inspection may be performed as well.

FIG. 2 is an exemplary flowchart illustrating a process method for the freeze-drying step 170 in more detail.

The freeze-drying incudes a freezing step 210 as a preliminary step. This step may correspond to the quick freezing step 160. In general, an object (e.g., a mixture) is frozen using liquid nitrogen, or is put in a refrigerator so as to be frozen. The freezing method may vary depending on the freeze-drier.

In the freezing step 210, when the pressure of the frozen object is lowered, the frozen solvent (e.g., water) transitions from a state in which it undergoes liquefaction from a solid phase to a liquid phase and to a state in which the solvent can sublimate from the solid phase to a gas phase.

Next, in the primary drying step 220, when the solvent reaches a state in which the solvent can be sublimated at a sufficiently low temperature and low pressure, the solvent is sublimated. For example, when the pressure is lowered, the moisture in the object is sublimated. The temperature and pressure at which moisture is sublimated vary slightly depending on the material constituting the object. In one embodiment, the sufficiently low temperature means-40° C. or a lower temperature, and the sufficiently low pressure means the vacuum state or a pressure close to the vacuum state. In one embodiment, the pressure close to the vacuum state is less than or equal to 1 Torr. In another embodiment, the pressure close to the vacuum state is less than or equal to 1 mTorr. In general, air is removed to lower the pressure, which depends on the freeze-drier. In the process, sublimated water vapor naturally escapes with the air.

After the primary drying is complete, all the ice is sublimated, but there is still moisture bound to the object. Bound water is also called residual moisture. When there is much residual moisture, the weight of the residual moisture may be about 7% to 8% of the weight of the moisture constituting the object before the primary drying is performed. Therefore, after the primary drying, the temperature may be increased through a subsequent secondary drying step until an optimum condition in which residual moisture can be sufficiently removed is obtained, such that the residual moisture is removed from the object.

Hereinafter, exemplary processes of the freeze-drying step 170 will be described. Prior to freeze-drying step 170, the object is frozen to about −40° C. under the condition of atmospheric pressure. This operation corresponds to the quick freezing step 160. In an embodiment, the quick freezing step 160 is performed over about 2 hours.

Table 1 below is an embodiment of the freeze-drying step 170 described above with reference to FIG. 2.

TABLE 1

| Step | 1 | 2 | 3 | 4 | 5 | 6 | 7 | 8 | 9 | 10 |
|---|---|---|---|---|---|---|---|---|---|---|
| Temp | −40.0 | −30.0 | −20.0 | −10.0 | 0.0 | 10.0 | 20.0 | 30.0 | 40.0 | 40.0 |
| (° C.) | | | | | | | | | | |
| VAC. | 0 | 0 | 0 | 0 | 0 | 0 | 0 | 0 | 0 | 0 |
| (mTorr) | | | | | | | | | | |
| Time | 60 | 180 | 180 | 180 | 180 | 180 | 180 | 180 | 180 | — |
| (min.) | | | | | | | | | | |

Referring to the embodiment of Table 1, in step 1, the object is treated at −40° C., a (vacuum) pressure of 0 for 1 hour. Step 1 corresponds to the primary drying step 220. Next, in steps 2 to 9, the temperature around the object is incremented by 10° C. up to the temperature of 40° C. (for about 24 hours). In step 10, residual moisture (moisture remaining without being sublimated) is removed from the object at 40° C. for about 48 hours. Steps 2 to 10 corresponds to the secondary drying step 230. Another embodiment of the freeze-drying step 170 described above with reference to FIG. 2 is performed as follows. First, the ambient air pressure of the object frozen to about −40° C. is lowered to 1 mTorr or less. Next, while maintaining the ambient air pressure of the object in a range of 1 mTorr to 1 Torr, the primary drying step 220 is performed for about 10 hours. In this operation, the ambient temperature of the object gradually rises from −40° C. to −30° C. Next, the secondary drying step 230 is performed by gradually increasing the ambient temperature of the object from −30° C. to 40° C. The secondary drying step 230 is performed for about 3 to 12 hours. In the secondary drying step 230, the atmospheric pressure around the object is maintained at 1 Torr or less.

In the above-described exemplary freeze-drying process, temperature and atmospheric pressure in each step or operation, and the retention time of each step or operation may be appropriately changed by a person skilled in the art according to an object to be freeze-dried.

Although a method of producing food or feed using an exemplary freeze-drying technique and an exemplary freeze-drying process have been described above, it should be understood that there are various types of freeze-drying process methods and a person skilled in the art may use any freeze-drying process method to produce food.

Feed can be produced using a freeze-drying technique, but there has not been feed produced with an insect as a raw material using a freeze-drying technique. In the present disclosure, feed produced with insects as a raw material using a freeze-drying technique is proposed. The feed proposed in the present disclosure includes insects or insect powder and starch. Other ingredients may also be included. Other ingredients can add characteristics, such as the taste or aroma, to feed. Hereinafter, an exemplary method 300 of producing feed with insects as a raw material using a freeze-drying technique will be described.

For feed produced with insects as a raw material using a freeze-drying technique, insects are usually processed in powder form. For very small insects, the step of processing the insects into powder form may be omitted. Hereinafter, for simplicity, insects processed into powder form and very small insects are collectively referred to as “insect powder.” As a raw material for insect powder, feed insects such as a brown mealworm, a Zophobas atratus, a Hermetia illucens, a housefly, a two-spotted cricket, an Oriental garden cricket, a silkworm moth, a Chironomidae larva, and other insects determined and publicly notified by government departments or institutions may be used, but embodiments are not limited to the listed insects. Typically, the Hermetia illucens (e.g., black soldier fly) may be used as a raw material for insect powder. Insect powder may be produced using a plurality of insects as raw materials.

In the case of producing feed by processing meat or fish and then freeze-drying the same, the meat or fish has its own viscosity and moisture, and thus it may clump together like dough in the freeze-drying process. On the other hand, insect powder contains little moisture, and thus will not clump when it is freeze-dried as it is. Therefore, there is a need for a medium to agglomerate the insect powder into a mass. Starch may be used as such a medium. Starch can be obtained from various raw materials such as sweet potatoes, flour, and tapioca. In general, in order to use starch as a medium for agglomerating insect powder, a starch containing raw material, such as wheat, potatoes, flaxseeds, barley, peas, lentils, chickpeas, brown rice, corn, sweet potatoes, tapioca, pumpkin, glutinous rice, and/or rice, may be combined with the insect powder. Alternatively, the raw material containing starch may be boiled and used. Alternatively, a powdered formulation of the raw material may be used. Alternatively, the raw material may be ground and used, or starch may be extracted from the raw material and used. By combining insect powder and starch 310 using at least one of the various methods, a basic base of feed is made. The combination of insect powder and starch is referred to as “dough.”

In order to make the insect powder more agglomerate, eggs, milk, water, and/or oil may be additionally added to the dough.

An additive such as blueberries, carrots, pumpkins, and/or bok choy may be added to the dough. The raw material or base material of the additional additive is not limited, and various raw materials or base materials may be added to produce characteristics of a feed such as various kinds of tastes/aroma/colors. For example, pumpkin, carrot, sweet potato, anchovy, dried pollack, zucchini, sweet pumpkin, tomato, dried kelp, blueberry, bok choy, and/or rosemary extract may be added to the dough.

The weight ratio of the raw materials used in the feed producing method according to the present disclosure may be determined according to at least one of a nutritional standard of AAFCO (Association of American Feed Control Officials), which is a non-profit organization in the United States that makes animal feed standards, a standard of “Nutrient Requirements of Dogs and Cats” published by NRC (National Research Council), or the European Pet Food Industry Federation (FEDIAF/European standards, non-profit organization).

Before freeze-drying, the dough and the added raw material or base material are mixed 320. If there is no added raw material or base material, the dough itself is mixed. This process may correspond to the mixing step 140. As a mixing method, an appropriate method that allows the dough and the added raw material or base material to be mixed well may be selected.

The dough or the mixture produced by mixing the dough and the added raw material or base material may be molded into a desired shape of feed 330. This operation may correspond to the molding step 150. In this step, the mixture lump is divided into several lumps, and each lump is molded into the shape of the feed. The shape of the feed may be determined using a mold of a desired shape. For example, the feed may be molded into a shape such as a sphere, an oval sphere, a cube, or a rectangular parallelepiped, or may be molded into a star shape or the like. In this case, the shape and/or size of the feed may be designed in consideration of an animal to ingest the feed.

Once the mixture is molded and shaped, the molded mixture is frozen 340 to prepare freeze-drying. This operation may correspond to the quick freezing step 160. Next, the frozen molded mixture is freeze-dried 350, which may correspond to the freeze-drying step 170. The freeze-dried feed is finally ready to be sold to the consumer through a packaging process, which may correspond to packaging step 180.

A feed may be produced by the exemplary method described above, using a freeze-drying technique employing insects as a raw material. At least one embodiment of the feed according to the present disclosure includes insect powder and starch. As a typical raw material for insect powder, the black soldier fly may be used. Alternatively, edible insects such as a grasshopper, a white-stuff silkworm, an edible silkworm larva and pupa, a brown mealworm larva, a two-spotted cricket, a white-spotted flower chafer larva, an Allomyrina beetle larva, a Zophobas atratus larva, and a migratory locust, or insects for feed such as a brown mealworm, a Zophobas atratus mealworm, a Hermetia illucens, a housefly, a two-spotted cricket, a Teleogryllus cricket, a silkworm moth, a Chironomidae larva, and other insects determined and publicly notified by the Minister of Agriculture, Food and Rural Affairs may be used. At least one embodiment of the feed according to the present disclosure includes raw materials containing starch, such as wheat, potato, flaxseed, barley, pea, lentil, chickpea, brown rice, corn, sweet potato, tapioca, pumpkin, glutinous rice, and/or rice, or powder form of the raw materials, or starch powder. At least one embodiment of the feed according to the present disclosure includes egg, milk, water, and/or oil in addition to insect powder or starch. At least one embodiment of the feed according to the present disclosure includes insect powder, starch, and additional additives. The Additional additives may include pumpkin, carrot, sweet potato, anchovy, dried pollack, zucchini, sweet pumpkin, tomato, dried kelp, blueberry, bok choy, and/or rosemary extract. According to at least one embodiment of the feed according to the present disclosure, the weight ratio of the raw materials is determined according to at least one of a nutritional standard of AAFCO, the “Nutrient Requirements of Dogs and Cats” published by NRC, and a nutritional standard of FEDIAF.

At least one embodiment of the feed according to the present disclosure includes 40 to 60% by weight of insect powder and 10 to 20% by weight of starch. At least one embodiment of the feed according to the present disclosure includes 40 to 60% by weight of insect powder, 10 to 20% by weight of starch, and 25 to 40% by weight of an additional additive. At least one embodiment of the feed according to the present disclosure includes 3 to 5% by weight of eggs, milk, water, and/or oil to better agglomerate the insect powder. In this specification, the weight % of the raw material means the weight % in the dry state except for liquids.

In at least one embodiment of the feed according to the present disclosure, 35% by weight of insect powder, 25% by weight of starch, 3% by weight of oil, 5% by weight of eggs, and 32% by weight of an additional additive may be provided, and the oil may be insect oil. FIG. 4 is a photograph of such feed.

It should be understood that feed may be produced by those skilled in the art by controlling the weight ratio of insect powder, starch, and/or various additional additives using a freeze-drying technique, and that the weight ratio of any raw material falls within the scope of the present disclosure.

What is claimed is:

1. A method for producing feed, comprising:
preparing a dough by combining insect powder and starch;
preparing a mixture using the dough;
molding the mixture; and
freeze-drying the mixture.

2. The method of claim 1, wherein the preparing of the mixture comprises:
mixing the dough with at least one of eggs, milk, water, or oil.

3. The method of claim 1, wherein a raw material of the starch is at least one of wheat, potato, flaxseed, barley, peas, lentils, chickpeas, brown rice, corn, sweet potato, tapioca, pumpkin, glutinous rice, or rice.

4. The method of claim 3, wherein the combining of the insect powder and the starch comprises at least one of:
combining the raw material of the starch with the insect powder;
boiling the raw material and combining the same with the insect powder;
combining a powdered formulation of the raw material with the insect powder; or
extracting the starch from the raw material and combining the extracted starch with the insect powder.

5. The method of claim 1, wherein the preparing of the mixture comprises:
mixing the dough and an additional additive.

6. The method of claim 5, wherein the additional additive is all or part of at least one of pumpkin, carrot, sweet potato, anchovy, dried pollack, zucchini, sweet pumpkin, tomato, dried kelp, blueberry, bok choy, or rosemary extract.

7. The method of claim 1, wherein a raw material of the insect powder is at least one of feed insects including a brown mealworm, a Zophobas atratus, a Hermetia illucens, a housefly, a two-spotted cricket, an Oriental garden cricket, a silkworm moth, a Chironomidae larva, or other insects determined and publicly notified by government departments or institutions.

8. A feed produced using a freeze-drying technique, the feed comprising insect powder and starch.

9. The feed of claim 8, further comprising at least one of eggs, milk, water, or oil.

10. The feed of claim 8, wherein a raw material of the starch is at least one of wheat, potato, flaxseed, barley, peas, lentils, chickpeas, brown rice, corn, sweet potato, tapioca, pumpkin, glutinous rice, or rice.

11. The feed of claim 8, further comprising all or part of at least one of pumpkin, carrot, sweet potato, anchovy, dried pollack, zucchini, sweet pumpkin, tomato, dried kelp, blueberry, bok choy, or rosemary extract.

12. The feed of claim 8, wherein a raw material of the insect powder is at least one of feed insects including a black soldier fly, a brown mealworm, a Zophobas atratus mealworm, a Hermetia illucens, a housefly, a two-spotted cricket, a Teleogryllus cricket, a silkworm moth, and a Chironomidae larva.
